(19) United States
(12) Patent Application Publication
(10) Pub. No.: US 2009/0125997 A1
(43) Pub. Date: May 14, 2009

(54) Network node with one-time-password generator functionality

(76) Inventor: Debra L Cook, Tinton Falls, NJ (US)

Correspondence Address: Lucent Technologies Inc.,;Docket Administrator - Room 2F-192, 600-700 Mountain Ave.,, Murray Hill, NJ, 07974-0636, US

(21) Appl. No.: 12/290,476

(22) Filed: Oct. 31, 2008

Related U.S. Application Data
(63) Continuation-in-part of application No. 11/732,199, filed on Apr. 3, 2007.

(51) Int. Cl. H04L 9/32

(52) U.S. Cl. 726/6

(57) ABSTRACT

Structures and methods are disclosed for facilitating secure connectivity of a remote client to an enterprise network using OTP-enabled nodes of a remote access platform. Embodiments described herein include an OTP device associated with a client device (for example and without limitation, an OTP device residing within a PC card associated with a laptop or desktop computer) defining a first node of a remote access platform; and an OTP server defining a second node of a remote access platform that generates and maintains the same OTP as the OTP device at the first node, for purposes of authenticating the client device and/or user of the client device.

### CROSS-REFERENCE TO RELATED APPLICATIONS

This invention is a continuation-in-part of U.S. patent application Ser. No. 11/732,199, titled “Method and Apparatus for Generating One-Time Passwords,” filed Apr. 3, 2007, assigned to the assignee of the present application and incorporated herein by reference.

### FIELD OF THE INVENTION

This invention relates generally to the art of authentication using one-time passwords (OTPs) and, more particularly, to integration of OTP functionality into one or more network nodes, for example and without limitation, to facilitate secure connectivity of a remote client to an enterprise network.

### BACKGROUND OF THE INVENTION

One-time password generators are devices (e.g., “tokens”) or software that generate a series of pseudorandom sequences (“passwords”) used, for example and without limitation, to establish secure connectivity and login to corporate enterprise networks and controlled-access portions of such networks (e.g., associated with payroll, restricted web pages, databases or the like). Most typically, OTP generators calculate a new password frequently (e.g., every 60 seconds) such that any given password is likely to be valid for only a single transaction (hence, they are known as “one-time” passwords), after which the token calculates a new password. Typically, a user initiates a secure connection to the enterprise network or controlled-access portion of the network by entering via a user interface, a personal identification number (PIN) concatenated with a currently displayed OTP instance of the token and sending to an authentication entity (e.g., server). The authentication entity calculates OTPs using the same mathematical algorithm as the token. The authentication entity also correlates the current OTP with the users PIN and can therefore authenticate a valid user if the OTP entered by the user matches the corresponding OTP generated by the authentication entity.

Parent patent application Ser. No. 11/732,199 describes various embodiments in which OTP sequences are generated on a communication device (comprising, for example, a mobile phone, PDA, notebook computer or portable media player), as an alternative to a dedicated OTP token maintained separately from the device, for use in applications including consumer and enterprise applications. The provision of OTP functionality in a communication device obviates or at least minimizes problems associated with separate physical tokens including loss, theft, loss-of-synch or expiration of tokens. The present application describes further embodiments in which OTP sequences are generated by communication devices as opposed to a dedicated OTP token; in particular, wherein OTP functionality is integrated into nodes of a remote access platform, for example, to facilitate secure connectivity of an end user client to an enterprise network or controlled-access portion of such network.

### SUMMARY OF THE INVENTION

The present invention is directed to integrating OTP functionality into nodes of a remote access platform, for example, to facilitate secure connectivity of a remote client to an enterprise network. Embodiments herein describe an OTP device associated with a client device (for example and without limitation, an OTP device residing within a PC card associated with a laptop or desktop computer) defining a first node of a remote access platform; and an OTP server defining a second node of a remote access platform that generates and maintains the same OTP instances as the OTP device at the first node, for purposes of authenticating the client device and/or user of the client device.

In one embodiment, there is provided an OTP device for facilitating connection of a remote client to an enterprise network, the OTP device defining a first node of a remote access platform. The OTP device comprises one or more sequence generators for generating OTPs; and means for communicating at least one instance of an OTP from the OTP device toward a second node of a remote access platform for the purpose of authenticating the client for access to the enterprise network.

In another embodiment, there is provided a remote access platform for facilitating connection of a remote client to an enterprise network. The remote access platform comprises an OTP device and an OTP server defining first and second nodes of the network access platform. The OTP device is associated with the client and includes one or more sequence generators for generating OTPs. The OTP server includes one or more sequence generators for generating OTPs corresponding to the OTP instances generated by the OTP device. The remote access platform includes means for authenticating at least one of the client and OTP server using one or more instances of the OTP sequences generated by the OTP device and OTP server.

In still other embodiments, there are provided methods for authenticating a client or user requesting access to an enterprise network using components of a remote access platform. The methods include one-way authentication of the client or user at a first node and two-way authentication of the client or user at a first node and a server at a second node.

### BRIEF DESCRIPTION OF THE DRAWINGS

The foregoing and other advantages of the invention will become apparent upon reading the following detailed description and upon reference to the drawings in which:

FIG. 1 is a block diagram illustrating nodes of a remote access platform (i.e., “Evros” platform) according to the prior art;

FIG. 2 depicts a generic OTP device associated with a client, the OTP device operable according to embodiments of the present invention facilitate secure connectivity of the client to an enterprise network;

FIG. 3 shows a message sequence according to a first exemplary embodiment of the present invention, utilizing OTP-enabled nodes of a remote access platform to perform one-way authentication of a remote client device attempting access to an enterprise network;

FIG. 4 shows a message sequence according to a second exemplary embodiment of the present invention, utilizing OTP-enabled nodes of a remote access platform to perform one-way authentication of a user attempting access to an enterprise application;

FIG. 5 shows a message sequence according to a third exemplary embodiment of the present invention, utilizing OTP-enabled nodes of a remote access platform to perform a two-way authentication sequence of a user and an OTP server; and

FIG. 6 shows a message sequence according to a fourth exemplary embodiment of the present invention, utilizing OTP-enabled nodes of a remote access platform to perform a two-way authentication sequence of a client device and an OTP server.

### DESCRIPTION OF THE PREFERRED EMBODIMENT(S)

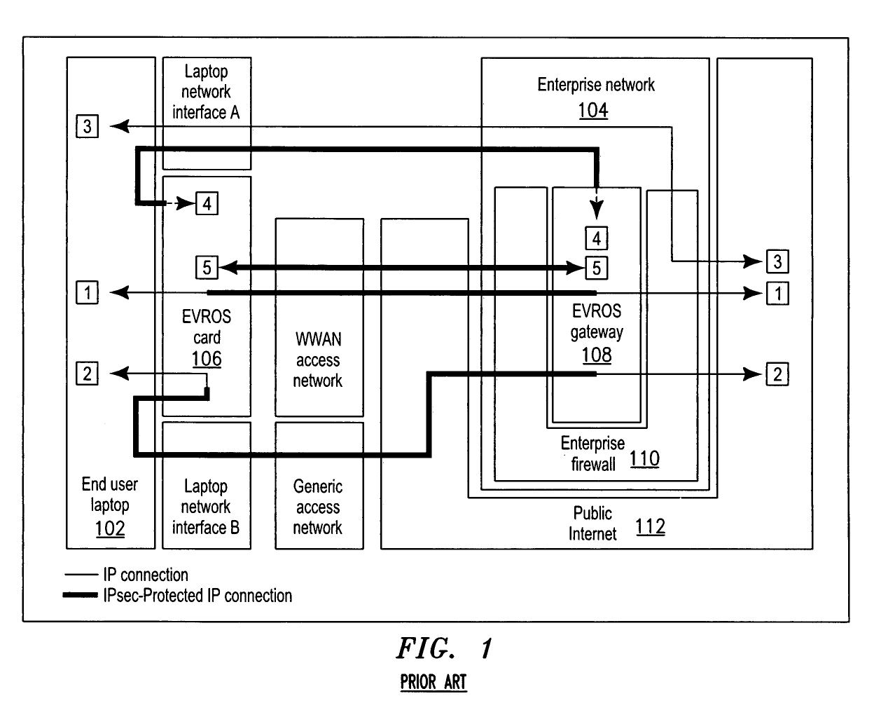

FIG. 1 is a block diagram illustrating nodes of a remote access platform (“Evros” platform) for connecting a remote client 102 (as shown, an end user laptop) to an enterprise network 104. The Evros platform is described in detail in “Evros: A Service-Delivery Platform for Extending Security Coverage and IT Reach,” Bell Labs Technical Journal Vol. 12, Issue 3, pp. 101-119. The Evros platform is implemented in the Alcatel-Lucent OmniAccess 3500. Nonstop Laptop Guardian product. The Evros platform is built on three components, an Evros card 106, an Evros gateway 108 and an Evros management server (not shown).

The Evros card 106 is a PC card that plugs into a PCMCIA slot of the laptop 102 and includes the following physical and functional elements:

a rechargeable battery that supplies power to the Evros card when the laptop is in standby, hibernate or shutdown state. During normal operation, the card draws power directly from the laptop.

a wireless modem that provides IP connectivity over a public or private wireless network. Different versions of the card support different wireless interfaces (1xEV-DO, EV-DOrA, HSDPA, HSUPA, WiMAX).

a non-volatile flash memory for storage of persistent data, security certificates, and client synchronization data. The memory is partitioned into user and system space, with the system partition inaccessible to the laptop.

An embedded central processing unit (CPU).

An embedded Linux™ platform that hosts on-card remote access functions, applications and services such as: a management link to the Evros gateway that enables functions like tunnel monitoring, software/firmware updates, and remote assistance; an authentication platform that associates an end user with unique instances of the Evros card and Evros driver; extended data traffic processing capabilities, including stateful packet inspection, full IP stack operation, PPP encapsulation, and IPsec encapsulation/encryption/decryption; and interface management capabilities for monitoring the quality of the access links offered by the surrounding networks and seamlessly switching between them.

An external on/off switch that, together with the on-card rechargeable battery, makes the power state of the card independent of the power state of the host laptop. The switch makes it possible to turn off the Evros card when the use of radio equipment is prohibited by official regulations, e.g., during takeoff and landing of commercial airplanes.

Support for both internal and external antennas.

Subscriber identity module (SIM) compatibility.

Security-lock functionality, such that the usability of the Evros laptop is compromised if the Evros card is removed.

The Evros card 106 works as a standalone network node attached to the laptop. It independently establishes and maintains the IPsec tunnel that affords authentication and encryption to the remote connection with the enterprise network, even at times when the laptop is not powered on. It hosts a personal firewall that applies the latest filtering policies set by the enterprise to all laptop-terminated traffic. It stages the file transfers between laptop and enterprise that are needed by device-management and end user applications, providing temporary storage when the receiving party is not ready.

The Evros gateway 108 is an enhanced remote access server that combines the following physical and functional elements:

Two network interfaces (10/100/1000 Mbps Ethernet), of which one is external (handling traffic to and from the public Internet) and one internal (facing the inner portion of the enterprise network 104).

A processing subsystem (CPU, OS, and Evros software) that implements the Evros functions.

A hardware acceleration module for IPsec encryption/decryption, key management and compression.

A hard disk for storage of local information and application caching.

A secure management interface for driving all Evros operation, administration, management, and provisioning (OAM&P) procedures.

The Evros gateway 108 terminates the secure tunnels, manages user credentials and security policies, and provides storage and file transfer capabilities in support of third-party remote access and device management applications. The gateway also cooperates with the Evros card 106 in ensuring that vertical handovers are not disruptive to running network applications.

The Evros gateway 108 is best deployed as a stub of the enterprise firewall 110. The firewall 110 and Evros gateway 108 exchange encrypted traffic over the external interface of the gateway and decrypted traffic over the internal interface. Thus the firewall 110 applies full protection to both the external interface of the Evros gateway 108 and the inner portion of the enterprise network. Multiple instances of the Evros gateway 108 can be deployed within the same enterprise network to increase capacity and extend geographical coverage and service availability.

The Evros management server (not shown) drives all the OAM&P functions concerning the Evros gateway 108, the Evros card 106, and, by extension, the Evros-enabled laptop 102. Such functions include remote configuration and provisioning, monitoring, reporting, logging, alarm generation, software distribution, and system administration. The EMS is also the repository for all policies, audit data, configuration information, and application data such as the asset inventories for the Evros-controlled laptops. The EMS can run on any network server, including the Evros gateway. The EMS supports backup, restoration, recovery, and optional encryption for all of its data.

The communication between the EMS and the Evros card is not direct and instead is conducted through the Evros gateway. The connection between the EMS and the Evros gateway is always secure with respect to confidentiality, integrity, and mutual authentication and is insensitive to the presence of network address translation (NAT) gateways and firewalls along the network path.

The types of network connections that the Evros-enabled laptop can establish are depicted by scenarios 1, 2, 3, 4 and 5 of FIG. 1.

When the laptop 102 is outside the enterprise premises, the network connection may be supported by the WWAN interface on the Evros card (scenario 1) or by one of the Ethernet or Wi-Fi interfaces on the laptop (scenario 2). After selecting the best surrounding access network (Ethernet, WLAN or WWAN), the Evros card 106 transparently activates the corresponding interface and uses it to reach one of the enterprise Evros gateways 108 for a certificate-based mutual authentication, followed by the establishment of a pair of unidirectional IPsec security associations (the IPsec tunnel). As part of this initial transaction, the card 106 obtains from the gateway 108 the pair of VPN addresses that will identify the card and the laptop within the enterprise network 104. The IPsec tunnel protects the laptop connection to the enterprise network 104 that also enables access to the public Internet 112.

When the laptop 102 is inside the enterprise premises, the Evros card 106 conducts the same network access procedure as in the extrapremises case, including the establishment of the IPsec tunnel to the Evros gateway 108. This way, the same policy controls apply to all user terminals irrespective of the access location. After the authentication server authorizes the user, the Evros card 106 removes itself from the host application data path (scenario 3) while maintaining the IPsec tunnel to the gateway 108 to support all OAM&P communications (scenario 4).

When the laptop 102 is not powered on, the Evros card 106 can wake up (either independently or upon receipt of a short message service [SMS] text message from the Evros gateway 108) and securely connect to the gateway through the WWAN interface (scenario 5). This type of connection enables remote management actions and bandwidth-consuming data file transfers during off-peak hours, when they neither interfere with end user utilization of the laptop nor compete for bandwidth resources with other network traffic.

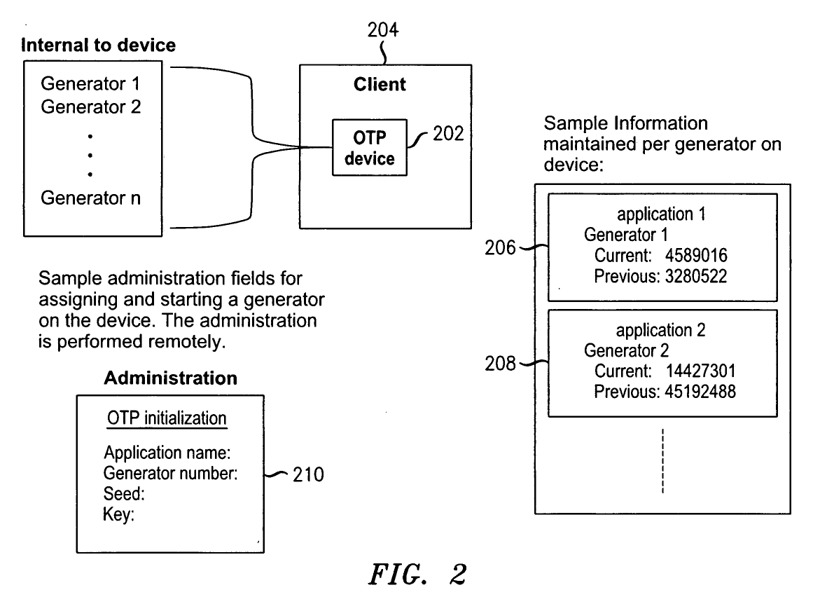

Now turning to FIG. 2, there is shown a generic diagram of an OTP device 202 associated with a client 204. In one embodiment, the OTP device 202 is integrated within an Evros-type PC card defining a first node of a remote access platform; and a corresponding OTP device 202 is integrated in an Evros-type gateway such as the type described in relation to FIG. 1 defining a second node of a remote access platform to facilitate connection of a laptop computer 204 to an enterprise network. As will be appreciated however, the OTP functionality may be integrated into any of several authentication modalities and may be adapted for use with different client devices.

One or more instances of a sequence generator, as shown, Generator 1, Generator 2 and Generator N, reside internal to the OTP device 202. The one or more sequence generators may correspond, for example, to one or more network entities or applications to be accessed by the client. The one or more instances of the sequence generators may be based, for example and without limitation, on a standard algorithm such as the Advanced Encryption Standard (AES). Each sequence generator encrypts a seed, i.e., an initial string of digits, with AES using a 16 byte key supplied by the user to the sequence generator to produce a separate pseudorandom sequence of alphabetical, numeric or alpha-numeric values of 6-8 characters. Also, each sequence generator computes the next value, i.e., a different pseudorandom sequence, after a predetermined interval, e.g., 60 seconds. Illustratively, one method to compute the next value is to have AES repeatedly encrypt the output of a previous encryption step, starting with the seed. This resulting ciphertext is then converted into a 6-8 character value for display to the user.

In the illustrative example of FIG. 2, fields 206, 208 represent sample information maintained per generator on OTP device 202. As shown, the output, i.e., a current sequence value and the previous sequence value, of each active sequence generator is shown on fields 206, 208 along with the name of an application (application 1, application 2) associated with the respective sequence generators. Further, field 210 represents administration information for use in initializing and synchronizing the OTPs with the various applications associated with the sequence generators. For example, field 210 may include information such as application name, generator number, seed number and key associated with each sequence generator.

As will be appreciated, the integration of OTP functionality in components of a remote access platform (e.g., Evros card or module associated with a client device) is advantageous in that it obviates the need for the user to carry both an Evros card/module and separate OTP token(s) possibly for multiple accounts; and also, since the Evros card is rechargeable, it obviates the need for the user to obtain replacement tokens from time to time as individual tokens age and/or their battery expires. Further, an OTP-enabled Evros-type card offers advantages relating to distribution and maintenance of IPsec certificates. The problem with certificates is that one needs to be created per client and distributed to the clients; certificates also expire and if the server's certificate is compromised, all of the clients are impacted because they can no longer be sure they are connected to the real server. The use of OTP-enabled cards and servers promotes authentication of users, clients and servers before or in conjunction with distribution of IPsec certificates or the like.

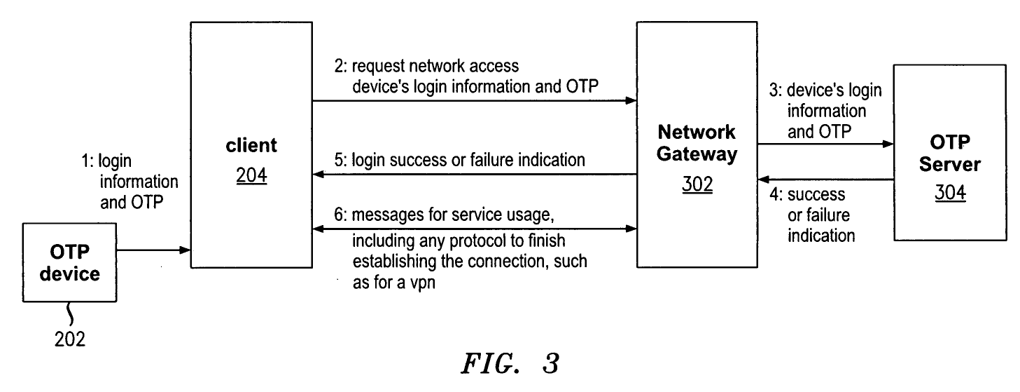

FIG. 3 shows a message sequence according to a first exemplary embodiment of the present invention, utilizing OTP-enabled nodes of a remote access platform to perform one-way authentication of a remote client 204 attempting access to an enterprise network. The elements of FIG. 3 include an OTP device 202, remote client 204, network gateway 302 and OTP server 304. In one embodiment, the OTP device 202 is associated with the client 204 (for example and without limitation, the OTP device 202 may comprise a PC card removably inserted in a laptop or desktop computer) defining a first node of a remote access platform. The network gateway 302 may comprise, for example, an Evros-type gateway of the type generally described in relation to FIG. 1; and the OTP server 304 an OTP-enabled management server defining a second node of the remote access platform. The OTP server may comprise, for example, an OTP-enabled version of the Evros management server described in relation to FIG. 1. As will be appreciated, the OTP server 304 is a functional element that may be included within the network gateway 302, a stand-alone server, network device or application or may be distributed among multiple devices or applications.

At 1, the OTP device 202 provides login information and an OTP to the client 204. The login information comprises generally, any information that uniquely identifies the client 204, for example and without limitation, the MAC address associated with the client 204. In this aspect, therefore, the OTP device 202 may be considered to be a component of the client. Alternatively, the OTP device may provide the OTP separately from the client login information (i.e., rely on the client to provide its own login information).

At 2, the client 204 requests access to the enterprise network and sends the login information and OTP to the network gateway 302. The handshake for requesting network access may be a step within an existing protocol, such as IPsec.

At 3, the network gateway 302 sends the login information and OTP to the OTP server 304. The OTP server 304 maintains a stored login ID associated with the OTP device 202 and includes an OTP generator corresponding to the device 202. The OTP server 304 will determine if there is a difference between the received device login information and OTP and the stored login ID and server-generated OTP.

At 4, the OTP server sends a message to the network gateway 302 indicating success or failure of login; and at 5, the network gateway forwards the message to the client 204.

At 6, provided the login is successful, the client 204 and network gateway 302 exchange messages for service usage, including any protocol to finish establishing the connection, such as for a VPN.

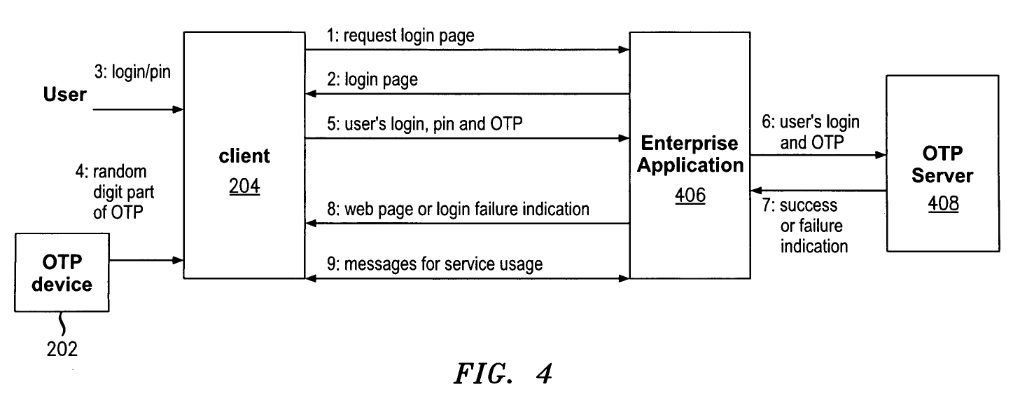

FIG. 4 shows a message sequence according to a second exemplary embodiment of the present invention, utilizing OTP-enabled nodes of a remote access platform to perform one-way authentication of a user attempting access to an enterprise application 406. The elements of FIG. 4 include an OTP device 202 associated with a client 204 and defining a first node of a remote access platform, such as described in relation to FIG. 2 and FIG. 3; an enterprise application 406 and OTP server 408 defining a second node of a remote access platform. The enterprise application 406 comprises, for example and without limitation, a controlled-access web server internal to the firewall of an enterprise network. The OTP server 408 is a functional element (such as the OTP server 304, FIG. 3) that generates and maintains the same OTP sequence as the OTP device 202, for purposes of authenticating the user of the client device.

At 1, using a web browser or other suitable interface of the client 204, the user requests a login page of the enterprise application 406. At 2, the enterprise application provides the login page.

At 3, the user provides login information and a PIN to the client 204. The login information may comprise, for example, an alpha-numeric user name that is uniquely used by the user to log in to an outlet of the enterprise LAN; and the PIN may comprise a digit sequence chosen by the user that is to be concatenated with an OTP to facilitate authentication of the user. As will be appreciated, however, the login information and PIN may take alternative forms.

At 4, the OTP device 202 provides an OTP to the client 204. Note that the OTP is the random digit portion of an OTP “password” typically formed by concatenating the PIN with the OTP. In the embodiment of FIG. 4, the PIN and OTP are provided separately to the client 204 by the user and OTP device 202 respectively.

At 5, the client 204 sends the login and PIN (provided by the user) and the OTP (provided by the OTP device) to the enterprise application 406. Depending on implementation, the client may or may not concatenate the PIN and OTP to form an OTP “password” before sending to the enterprise application 406.

At 6, the enterprise application 406 sends the user's login information and the OTP to the OTP server 408. The OTP server 408 maintains stored login information associated with the user and includes an OTP generator corresponding to the device 202. The OTP server 408 will determine if there is a difference between the received login information and OTP and the stored login information and server-generated OTP.

At 7, the OTP server sends a message to the enterprise application indicating success or failure of login; and at 8, the enterprise application forwards the message to the client 204.

At 9, provided the login is successful, the client 204 and enterprise application exchange messages for service usage.

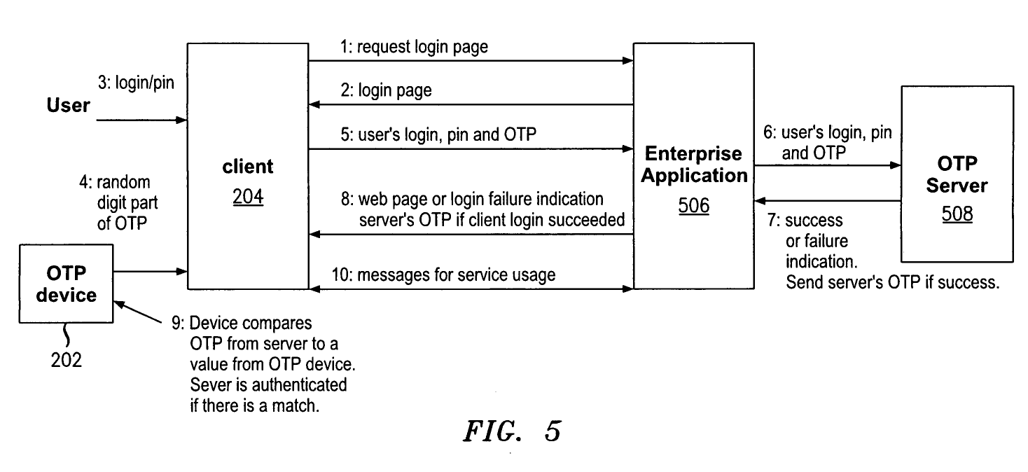

FIG. 5 shows a message sequence according to a third exemplary embodiment of the present invention, utilizing OTP-enabled nodes of a remote access platform to perform two-way authentication between the user of a remote client device and an OTP server 508. The elements of FIG. 5 include an OTP device 202 associated with a client 204 and defining a first node of a remote access platform such as described in relation to FIG. 2-4, an enterprise application 506 and OTP server 508 defining a second node of a remote access platform. The enterprise application 506 comprises, for example and without limitation, a controlled-access web server internal to the firewall of an enterprise network. The OTP server 508 is a functional element (such as the OTP server 304, FIG. 3) that generates and maintains the same OTP sequence as the OTP device 202, for purposes of authenticating the user of the client device.

At 1, using a web browser or other suitable interface of the client 204, the user requests a login page of the enterprise application 506. At 2, the enterprise application provides the login page.

At 3, the user provides login information and a PIN to the client 204. The login information may comprise, for example, an alpha-numeric user name that is uniquely used by the user to log in to an outlet of the enterprise LAN; and the PIN may comprise a digit sequence chosen by the user that is to be concatenated with an OTP to facilitate authentication of the user. As will be appreciated, however, the login information and PIN may take alternative forms.

At 4, the OTP device 202 provides an OTP to the client 204. Note that the OTP is the random digit portion of an OTP “password” typically formed by concatenating the PIN with the OTP. In the embodiment of FIG. 5, the PIN and OTP are provided separately to the client 204 by the user and OTP device 202 respectively.

At 5, the client 204 sends the login and PIN (provided by the user) and the OTP (provided by the OTP device) to the enterprise application 506. Depending on implementation, the client may or may not concatenate the PIN and OTP to form an OTP “password” before sending to the enterprise application 506.

At 6, the enterprise application 506 sends the user's login information and the OTP to the OTP server 508. The OTP server 508 maintains stored login information associated with the user and includes an OTP generator corresponding to the device 202. The OTP server 508 will determine if there is a difference between the received login information and OTP and the stored login information and server-generated OTP.

At 7, the OTP server sends a message to the enterprise application indicating success or failure of login; and at 8, the enterprise application forwards the message to the client 204. If the login was successful, the server will return its OTP along with the success indication.

At 9, the OTP device 202 will compare the server-generated OTP and the OTP generated by the OTP device 202. If the OTPs match, the server is authenticated.

At 10, provided the login is successful, the client 204 and enterprise application exchange messages for service usage.

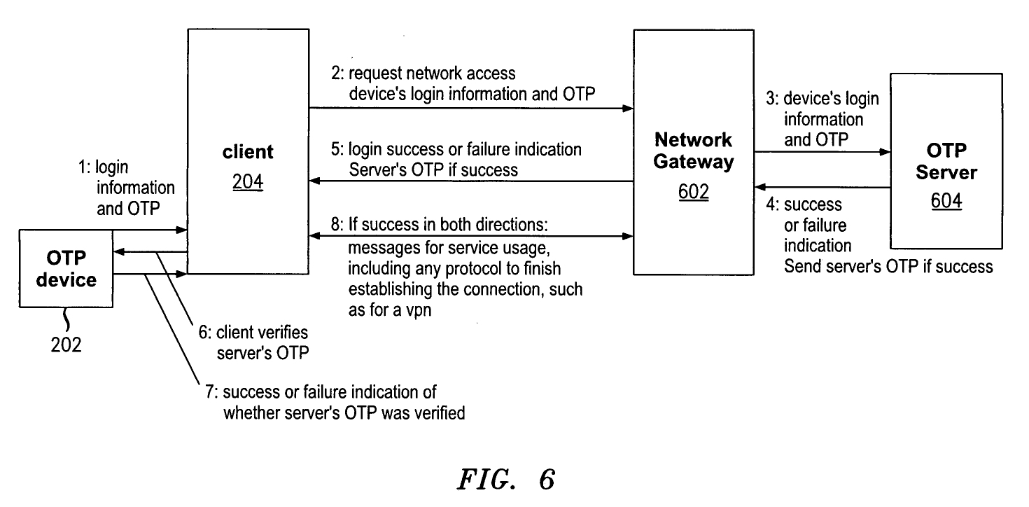

FIG. 6 shows a message sequence according to a fourth exemplary embodiment of the present invention, utilizing OTP-enabled nodes of a remote access platform to perform two-way authentication between a remote client device 204 and an OTP server 604. The elements of FIG. 6 include an OTP device 202 associated with a client 204 and defining a first node of a remote access platform such as described in relation to FIG. 2-5, a network gateway 602 and OTP server 604 defining a second node of a remote access platform. The network gateway 602 may comprise, for example, an Evros-type gateway of the type generally described in relation to FIG. 1; and the OTP server 604 a functional element (such as the OTP server 304, FIG. 3) that generates and maintains the same OTP as the OTP device 202, for purposes of authenticating the client device.

At 1, the OTP device 202 provides login information and an OTP to the client 204. The login information comprises generally, any information that uniquely identifies the client 204, for example and without limitation, the MAC address associated with the client 204. Alternatively, the OTP device may provide the OTP sequence separately (i.e., without client login information) and rely on the client to provide its own login information.

At 2, the client 204 requests access to the enterprise network and sends the login information and OTP to the network gateway 602. The handshake for requesting network access may be a step within an existing protocol, such as IPsec.

At 3, the network gateway 602 sends the login information and OTP to the OTP server 604. The OTP server 604 maintains a stored login ID associated with the OTP device 202 and includes an OTP generator corresponding to the device 202. The OTP server 604 will determine if there is a difference between the received login information and OTP and the stored login ID and server-generated OTP.

At 4, the OTP server sends a message to the network gateway 602 indicating success or failure of login. If the login is successful, the OTP server will send a server-generated OTP to the network gateway 602.

At 5, the network gateway forwards the success or failure indication to the client 204. If the login is successful, the network gateway also forwards the server-generated OTP to the client 204.

At 6, the client forwards the server-generated OTP to the OTP device 202. The OTP device 202 will compare the server-generated OTP and the OTP sequence generated by the OTP device 202. If the OTP sequences match, the server is authenticated.

At 7, the OTP device 202 sends a message to the client 204 indicating whether or not the OTP server 604 is authenticated.

At 8, provided authentication is successful in both directions, the client 204 and network gateway 602 exchange messages for service usage, including any protocol to finish establishing the connection, such as for a VPN.

The present invention can be embodied in the form of methods and apparatuses for practicing those methods. The present invention can also be embodied in the form of program code embodied in tangible media, such as floppy diskettes, CD-ROMs, hard drives or any other machine-readable storage medium, wherein, when the program code is loaded into and executed by a machine, such as a computer or processor, the machine becomes an apparatus for practicing the invention. The present invention can also be embodied in the form of program code, for example, whether stored in a storage medium, loaded into and/or executed by a machine or transmitted over some transmission medium or carrier, such as over electrical wiring or cabling, through fiber optics, or via electromagnetic radiation, wherein, when the program is loaded into and executed by a machine, such as a computer, the machine becomes an apparatus for practicing the invention.

It should also be understood that the steps of the exemplary methods set forth herein are not necessarily required to be performed in the order described, additional steps may be included in such methods, and certain steps may be omitted or combined in methods consistent with various embodiments of the present invention.

What is claimed is:

1. An OTP device for facilitating connection of a remote client to an enterprise network, the OTP device defining a first node of a remote access platform, the OTP device comprising:
one or more sequence generators for generating one-time passwords (OTPs);
means for communicating at least one instance of an OTP from the OTP device toward a second node of a remote access platform for purpose of authenticating the client for access to the enterprise network.

2. The OTP device of claim 1, comprising an OTP-enabled PC card, wherein the remote client comprises one of a laptop and desktop computer equipped with the OTP-enabled PC card.

3. The OTP device of claim 1, comprising an OTP-enabled module detachably connected to a client selected from the group consisting of a) a mobile telephone, b) a personal digital assistance (PDA) device, and c) a portable media player.

4. A remote access platform for facilitating connection of a remote client to an enterprise network, the remote access platform comprising:
an OTP device associated with the remote client and defining a first node of the network access platform, the OTP device including one or more sequence generators for generating one-time passwords (OTPs); and
an OTP server defining a second node of the remote access platform, the OTP server including one or more sequence generators for generating OTPs corresponding to the OTPs generated by the OTP device; and
means for authenticating at least one of the client and OTP server using one or more instances of the OTPs generated by the OTP device and OTP server.

5. The remote access platform of claim 4, wherein the OTP device comprises an OTP-enabled PC card, and wherein the remote client comprises one of a laptop and desktop computer equipped with the OTP-enabled PC card.

6. The remote access platform of claim 4, wherein the OTP device comprises an OTP-enabled module detachably connected to a client selected from the group consisting of a) a mobile telephone, b) a personal digital assistance (PDA) device, and
c) a portable media player.

7. A method of using one-time passwords (OTPs) to authenticate a client requesting access to an enterprise network, the method comprising:
generating an OTP instance from an OTP device associated with the client and defining a first node of a remote access platform;
transmitting the OTP instance with client login information to a second node of a remote access platform that is operable to authenticate the client based on the OTP instance generated by the OTP device and a corresponding OTP instance generated by the second node of the remote access platform.

8. The method of claim 7, wherein the step of transmitting comprises transmitting the OTP instance with client login information from the first node of the remote access platform to a network gateway, the network gateway forwarding the OTP instance with client login information to the second node of the remote access platform.

9. The method of claim 7, further comprising receiving indication of successful login if the OTP instance generated by the OTP device matches a corresponding OTP instance generated by the second node of the remote access platform.

10. The method of claim 7, further comprising:
receiving, by the client, an OTP instance generated by the second node of the remote access platform;
communicating the OTP instance from the client to the OTP device associated with the client and defining the first node of the remote access platform, the OTP device operable to authenticate the second node based on the OTP instance generated by the second node and the corresponding OTP instance generated by the OTP device.

11. A method of using one-time passwords to authenticate a user requesting access to an enterprise application, the method comprising a remote client device performing steps of:
receiving an OTP instance from an OTP device associated with the client and defining a first node of a remote access platform;
receiving login information from the user;
transmitting the OTP instance with user login information to a second node of a remote access platform that is operable to authenticate the client based on the OTP instance generated by the OTP device and a corresponding OTP instance generated by the second node of the remote access platform.

12. The method of claim 11, wherein the step of transmitting comprises transmitting the OTP instance with user login information from the first node of the remote access platform to an enterprise application, the enterprise application forwarding the OTP instance with user login information to the second node of the remote access platform.

13. The method of claim 11, further comprising receiving indication of successful login if the OTP instance generated by the OTP device matches a corresponding OTP instance generated by the second node of the remote access platform.

14. The method of claim 11, further comprising the client device:
receiving an OTP instance generated by the second node of the remote access platform;
communicating the OTP instance to the OTP device associated with the client and defining the first node of the remote access platform, the OTP device operable to authenticate the second node based on the OTP instance generated by the second node and the corresponding OTP instance generated by the OTP device.
